(19) United States
(12) Patent Application Publication
(10) Pub. No.: US 2024/0271601 A1
(43) Pub. Date: Aug. 15, 2024

(54) Single-Point-Mooring Wind Turbine with Two Wind Energy Conversion Units Each Having a Rotor

(71) Applicant: Aerodyn Consulting Singapore PTE LTD, Singapore (SG)

(72) Inventor: Sönke SIEGFRIEDSEN, Rendsburg (DE)

(73) Assignee: Aerodyn Consulting Singapore PTE LTD, Singapore (SG)

(21) Appl. No.: 18/570,408

(22) PCT Filed: Jun. 22, 2022
(86) PCT No.: PCT/IB2022/055778

§ 371 Date: Dec. 14, 2023

(30) Foreign Application Priority Data
Jul. 15, 2021 (DE) 10 2021 118 329.4

(51) Int. Cl. F03D 7/04; F03D 7/02

(52) U.S. Cl. CPC F03D 7/048; F03D 7/0204; F03D 7/0224; F03D 7/0276; F05B 2270/321

(57) ABSTRACT

The invention relates to a single-point-mooring wind turbine, comprising: two wind energy conversion units, which each have a rotor; turbine controllers, each of which is assigned to one of the energy conversion units and is designed to control the energy conversion unit in question independently of the other energy conversion unit in accordance with the operating parameters relating to the energy conversion unit in question. The wind turbine has a master controller, which acts on the turbine controllers and is designed to specify operating parameters adapted to both energy conversion units.

The invention relates to a single-point-mooring wind turbine having two wind energy conversion units, each having a rotor, in each case, a turbine controller assigned to an energy conversion unit, which turbine controller is configured to control and regulate the particular energy conversion unit independent of the other energy conversion unit according to the operating parameters relating to the particular energy conversion unit.

After the boom of wind energy on land (“onshore”) and later at sea (“offshore”), floating wind turbines for deeper water bodies have been increasingly under development. Various designs are proposed for this purpose. On the one hand, systems are known that are connected to the seabed in a rotationally stable manner via a plurality of anchor devices. As on land, these wind turbines must be equipped with wind direction tracking. This means an increased head weight and higher costs, not only for the turbine itself, but also for the floating foundation (“floater”). On the other hand, systems are known that dispense with the yaw system, and the entire floater rotates about an anchor referred to as a single point mooring. These systems have the advantage that the head weight is significantly reduced, and the tracking in the wind direction automatically adjusts optimally, since the turbines in this case have to be designed as downwind systems. Such single-point-mooring wind turbines are known, for example, from US 2011 140 451 AI, EP 1 269 018 AI, DE 10 2013 111 115 B3, EP 3 019 740 B1 and DE 102016118 079 B3.

In open water tests, however, it has been found to be disadvantageous in the latter offshore wind turbines for the entire turbine to tilt to one side due to the torque of the rotor in accordance with the moments that occur and the resulting equilibrium of forces. In large offshore wind turbines, the angle of inclination can indeed be up to 5° or more, wherein the inclination in turn ensures that the vector of the rotor thrust no longer lies on a line with the wind direction about the pivot point of the turbine in the water. As a result, a torque about the vertical axis of the turbine is generated about the pivot point so that the entire system rotates out of the wind direction. In the case of a rotor rotation in a clockwise direction viewed from the wind direction, the turbine therefore tilts to the right and, as seen from above, executes a leftward rotation. The resulting wind direction deviation can reach 20° to 40° and leads to unacceptable energy losses of approximately 25-30%.

In order to prevent this torque-induced oscillation of the single-point-mooring wind turbine, measures are already known from WO 2020/016643 A1 that enable stabilization of the floating offshore wind turbine and, accordingly, alignment of the single-point-mooring wind turbine in conformance with the wind direction.

Single-point mooring wind turbines, on the other hand, which have two energy conversion units as known, for example, from WO 2017/206976 A1, can be expected to avoid the misalignment described above, at least in the case of oppositely rotating rotors, due to the compensation of the rotor torques resulting from the opposite rotation of the rotors.

In fact, further investigations by the applicant have revealed that, even with a single-point-mooring wind turbine with two wind energy conversion units with rotors rotating in opposite directions, the demand for optimized wind orientation exists, so that the general object of the present invention is to further develop a single-point-mooring wind turbine having two energy conversion units so that a stable alignment in conformance with the wind direction is also made possible for this wind turbine.

This object is achieved according to the invention by the single-point-mooring wind turbine having the features of claim 1, the method according to claim 8, the method according to claim 14, and the method according to claim 15. Each of the dependent claims describes advantageous embodiments of the invention.

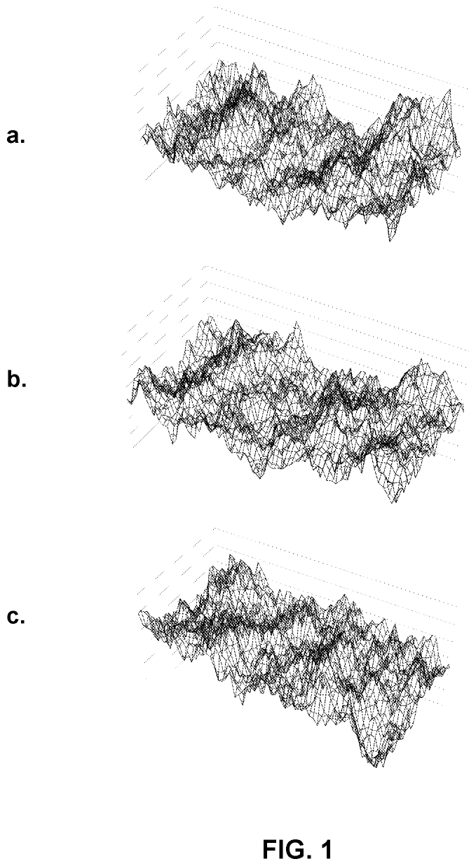

The invention is namely based on the insight that, due to the uneven distribution of the wind speeds over the rotor area swept by the rotors, in particular due to the wind speed differences in the particular rotor area between the rotors, torques also occur around the single-point-mooring system so that single-point-mooring wind turbines with two energy conversion units have the tendency to rotate out of the wind direction and thereby suffer energy losses. In this regard, FIG. 1 shows the model calculation of the axial wind speed components over the total area of the two rotors for the energy conversion units. Three consecutive 15 sec. intervals are shown. It can be seen that the wind speeds fluctuate spatially and temporally. This leads to considerable alternating loads in the entire structure of the turbine, wherein the sum of these loads also leads, among other things, to a torque about the pivot point.

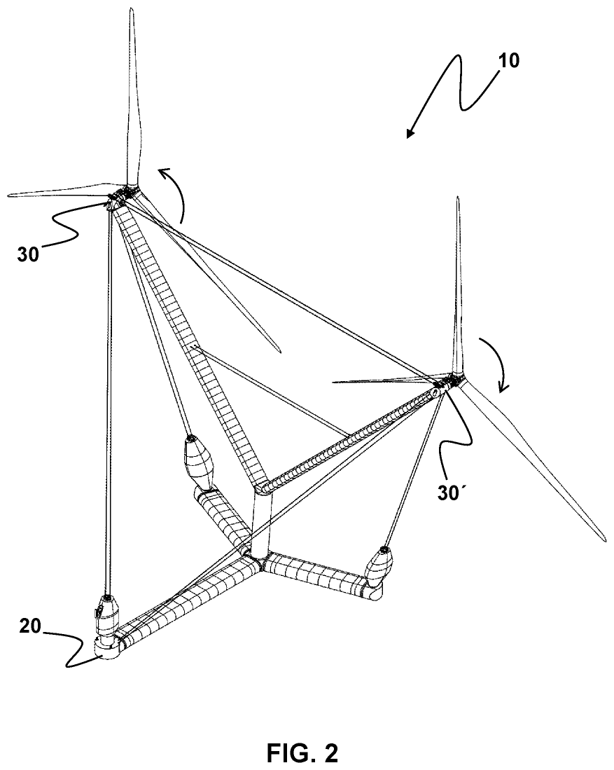

Accordingly, a single-point-mooring wind turbine 10 known in principle from WO 2017/206976 A1 and shown in a perspective view in FIG. 2, which has two wind energy conversion units 30, 30′ with rotors rotating in opposite directions, and is configured overall to be rotatable about an anchor 20 designed as a single point mooring, will rotate out of the wind under wind conditions acting unevenly on the rotors similar to that already illustrated for a turbine with only one rotor in WO 2020/016643 A1. In particular, the rotor for the wind energy conversion unit 30′ located on the right as viewed in the wind direction rotates clockwise, and the rotor for the turbine 30 located on the left as viewed in the wind direction rotates counterclockwise. This leads to a better utilization of the guy rope load than when the direction of rotation of the two turbines 30, 30′ is reversed.

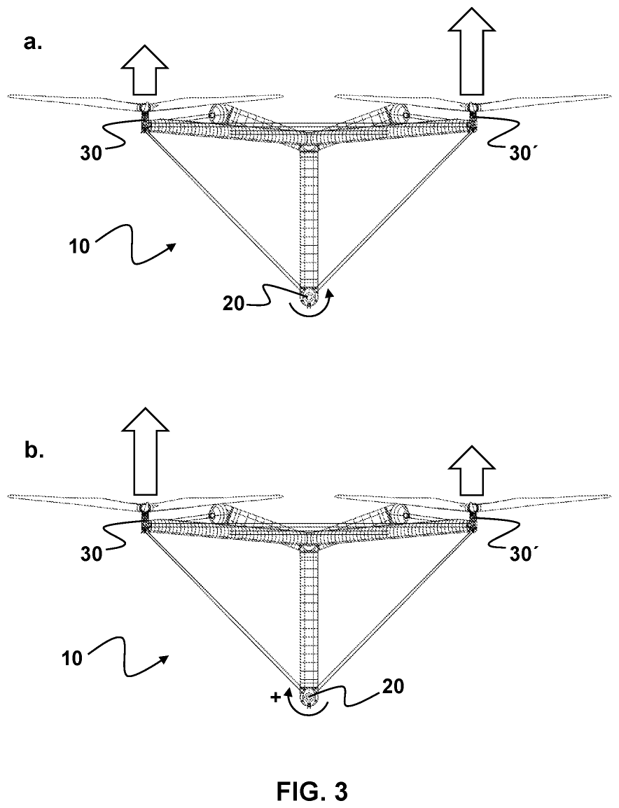

Accordingly, FIG. 3 shows in each case in plan view that, given a higher thrust force of one or the other rotor indicated accordingly by arrows, a rotation, i.e. a yawing of the single-point-mooring wind turbine 10 about the anchor 20 counterclockwise (a) or clockwise (b) will occur due to differential thrust forces.

In principle according to a particularly preferred exemplary embodiment, the invention consists of providing a single-point-mooring wind turbine having a plurality of energy conversion units in which each energy conversion unit has a turbine controller, which controls the operating state of each unit in detail per se and is responsible for all monitoring and control operations of the respective energy conversion unit to be equipped with a master controller, which is responsible for monitoring and controlling the alignment of the entire single-point-mooring wind turbine relative to the wind direction and, in accordance with predetermined boundary conditions, acts on at least one turbine controller in the event of deviations of the alignment from the wind direction in order to ensure optimum alignment with the wind direction. In addition, the master controller takes over the tasks of regulated start-up and shutdown of both turbines in accordance with preferred embodiments, as will be illustrated in the following.

In particular on the basis of the actual data supplied by the turbine controllers of the rotational speed (n₁ᵢ, n₂ᵢ), the electrical power (P₁ᵢ, p₂ᵢ), the wind speed (v₁ᵢ, v₂ᵢ), the pitch angle (β₁ᵢ, β₂ᵢ) and torque (M₁ᵢ, M₂ᵢ) of the particular wind energy conversion unit, the master controller determines the setpoint values for the rotational speed (n₁ₛ, n₂ₛ) and/or the torque (M₁ₛ, M₂ₛ) and/or the pitch angle (β₁ₛ, β₂ₛ) of the respective energy conversion unit.

The advantage of this embodiment is that turbine controllers that were previously designed and certified for individual turbines and are known to consist of different modules, which communicate via a bus system that is continuously monitored for fault-free operation, can be accessed, and an adaptation to the particular embodiment as a single-point-mooring wind turbine can be made via the master controller.

The goal of using a master controller is, in any case, to minimize the misalignment due to wind differences, wind direction changes, and possible currents or waves. This can take place by adapting the torques generated by the energy conversion units, the pitch angle adaptation of the rotor blades and/or the adjustment of the rotor rotational speed of the rotors. Regardless of which parameter is used for control by the master controller, the goal in all cases is to adapt the thrust of the two energy conversion units in order to enable a rotation of the entire wind turbine about the vertical axis of the anchor point, that is to say a yaw, which ensures an optimal energy yield by means of an optimal orientation in the wind direction.

With active torque adaptation, the generator torque for that energy conversion unit, which is responsible for the higher thrust, is reduced briefly, and/or the generator torque of the other system is increased briefly.

The pitch adaptation aims to achieve the same success by rotating the rotor blades of the same energy conversion unit to a lower angle of attack of the rotor blade profiles relative to the effective direction of inflow to thereby reduce the thrust of that energy conversion unit. At the same time or alternatively, the angle of attack of the other turbine can also be increased as far as aerodynamically possible.

Finally, the rotor rotational speed is adapted in combination with the torque adaption: while the rotational speed of the energy conversion unit generating an excessively high torque is reduced when the thrust is too high, the master controller acts so that the affected turbine controller executes an increase in rotational speed when the thrust is too low. To the extent that the electrical components are designed for this purpose, an energy conversion unit can also be operated briefly with a higher nominal torque and excess power, thereby increasing the energy yield. At the same time, it is conceivable for an energy conversion unit to be operated with a higher torque and the second energy conversion unit to be operated with a lower torque so that the total power is balanced overall.

In particular, the following parameters can be set for controlling both turbines by means of the master controller, wherein the yaw angle deviation is defined as the deviation of the orientation of the rotor axes of the single-point-mooring wind turbine relative to the temporal and spatial average wind direction and the yaw controller as the controller software, which acts on one or both turbines in order to achieve an optimal orientation:
maximum allowable yaw angle deviation for activation of the yaw regulation;
minimum time of exceeding the yaw angle deviation for activation;
minimum allowable yaw angle deviation for deactivation of the yaw regulation;
minimum time of undershooting the yaw angle deviation limit for deactivation of the yaw regulation, and
P, I, D amplification factors for the PID controller of the yaw regulation.

The most effective way to optimize yield is achieved by combining several adaptations. These are based on a YAW RPM controller, which reduces the setpoint value of the rotor rotational speed in the partial load range and reduces the torque or the rotor rotational speed in the full load range in order to achieve a thrust adaptation of both turbines and, accordingly, achieve a rotation of the single-point-mooring wind turbine about the center of rotation in order to optimally realign with the wind.

Depending on the sign of the yaw angle deviation, the rotational speed controller changes the thrust to the two turbines in which the rotational speed in the one turbine remains elevated or adjustable and/or is reduced in the other turbine and accordingly leads to a reduction in thrust. The level of the rotational speed difference imposed by the rotational speed controller as a function of the yaw angle deviation is specified in a value table or defined by a function.

The controller should be activated when a maximum permissible yaw angle deviation, which can be set as an input parameter, is exceeded. For a clockwise yaw angle deviation in a bird's eye view, a maximum difference of the rotor rotational speeds is n₁ᵢ-n₂ᵢ for the two systems with a positive sign is allowed. When the maximum is exceeded, the setpoint value of the rotor rotational speed n₁ₛ of the left turbine viewed in the wind direction is reduced to the sum of the current value of the right turbine and the difference from a predetermined value table.

For a counterclockwise yaw angle deviation in a bird's eye view, a maximum difference of the rotor rotational speeds n₁ᵢ-n₂ᵢ of the two systems is defined with a negative sign and, when undershot, leads to a reduction of the rotor rotational speed n₂ₛ of the turbine on the right as seen in the wind direction.

Thus, according to the invention, a single-point-mooring wind turbine is proposed, which has at least two wind energy conversion units, each having a rotor, a turbine controller associated with each energy conversion unit, and a master controller acting on the turbine controllers and configured to specify operating parameters adapted to both energy conversion units. In this case, each turbine controller is designed in principle to regulate the respective energy conversion unit independently of the other energy conversion unit according to the operating parameters relating to the particular energy conversion unit. The master controller, on the other hand, is configured to coordinate the operation of the energy conversion units with each other and, in addition to minimizing the yaw angle deviation, regulates processes, such as the regulated start-up and regulated shutdown of the single-point-mooring wind turbine, in particular.

The energy conversion units are preferably designed identically with respect to the rotor diameter, the power and/or the thrust characteristic.

In general, the turbine controllers and the master controller are not necessarily to be understood as independent objective hardware units. Rather, the mentioned controllers can be functional software units, which can also be accommodated by common PLC hardware (programmable logic controller).

In particular, the turbine controllers and the master controller are software that is specifically processed by a processor.

The single-point-mooring wind turbine further preferably has a device for detecting a yaw angle that deviates from the average wind direction acting on the single-point-mooring wind turbine, wherein the master controller is configured to position the single-point-mooring wind turbine at a predetermined yaw angle relative to the average wind direction. In particular, the term “average wind direction” used in connection with the present invention is the temporally and spatially average wind direction. The average wind direction and wind speed is determined in particular by means of preferably at least three wind measuring devices, wherein it is preferably provided that, in each case, one wind measuring device is arranged in the region of the energy conversion units, and one wind measuring device is arranged in the region of the center of rotation of the wind turbine.

A linearly weighted moving average is preferably calculated as the yaw angle deviation. The linearly weighted moving average is an average value over a defined number of moving measured values taking into account a weighting factor, which depends on the point in time of the particular measured value within the time period of the moving average. For example, with a moving measurement period of 60 seconds and second measured values that are read in, the current measurement value is multiplied by the factor A, then each temporally earlier measured value by a lower factor of e.g. A/60. The decrease in the weighting factor in this case runs linearly so that the more recent the measurement value, the more it is included in the moving average. This leads to the fact that events which took place longer ago are not taken into account as much.

In particular, the single-point-mooring wind turbine has a master controller that is configured to position the single-point-mooring wind turbine within the predetermined yaw angle range when the single-point-mooring wind turbine is oriented at an angle relative to the average wind direction outside of the predetermined yaw angle range.

Additionally or alternatively, when a yaw angle change occurring within a predetermined time is detected, the master controller can be configured to effect a yaw angle change counteracting the amount of yaw angle change that has occurred.

A particularly advantageous embodiment of components advantageously interacting with one another is achieved when the rotors of the single-point-mooring wind turbine are configured to rotate in opposite directions. The advantage of this embodiment is that the dynamic loads of the turbine are largely canceled out due to the opposing torques of the preferably structurally identical energy conversion units, and the required regulation is very low.

Furthermore, according to the invention, a method is provided for operating a floating single-point-mooring wind turbine having at least two energy conversion units, wherein each energy conversion unit has a rotor, wherein there is an independent regulation of the energy conversion units according to the operating parameters relating to the particular energy conversion unit within the predetermined yaw angle range that deviates from the average wind direction acting on the single-point-mooring wind turbine, and a regulation of the other energy conversion unit that is matched to the operating parameters of the one energy conversion turbine when the single-point-mooring wind turbine is oriented at an angle to the average wind direction outside the predetermined yaw angle range to reposition the single point mooring wind turbine within the predetermined yaw angle range or, when a yaw angle change occurring within a predetermined time is detected, to cause a yaw angle change counteracting the amount of yaw angle change that occurred.

In this case, it is preferably provided that the energy conversion units are regulated in a coordinated manner under the condition that the single-point-mooring wind turbine is oriented outside the predetermined yaw angle range for a predetermined time. The predetermined yaw angle range is preferably in the range of at most ±5°-10° from the temporal and spatial average of the wind direction.

The single-point-mooring wind turbine is repositioned in particular by changing the torque of at least one of the energy conversion units, changing the pitch angle of at least one of the energy conversion units, and/or changing the rotor rotational speed of at least one of the energy conversion units.

According to an alternative preferred embodiment, the single-point-mooring wind turbine may also be repositioned by reducing the difference in rotor rotational speeds of the energy conversion units by means of a predetermined table reflecting the dependence of the yaw angle on the difference in rotor rotational speeds.

The single-point-mooring wind turbine is preferably switched off, inter alia, when a maximum yaw angle deviating from the average wind direction is exceeded. In order to minimize the loads on the single-position-mooring system in such a case, both systems are switched off simultaneously with the same shutdown procedure.

Furthermore, a method for starting up a floating single-point-mooring wind turbine having at least two energy conversion units is proposed, wherein each energy conversion unit has a rotor, with the following steps: after releasing the two turbines for operation, depending on the wind conditions, one or the other turbine will start to spin; upon reaching a lower threshold speed, this turbine is accelerated by regulating the pitch to a predetermined limit rotational speed; at that point, this turbine is kept at a constant speed; after starting the other energy conversion unit, when this predetermined limit rotational speed is reached, the rotational speed of both energy conversion units is increased until the rotational speed required for grid operation is reached, and the coupling to the grid of both energy conversion units is carried out simultaneously. This embodiment allows controlled start-up without greater thrust differences of the energy conversion units of the single-point-mooring wind turbine, wherein after start-up, each turbine controller takes control of the particular turbine independently of the other turbine.

Finally, a method is also proposed for shutting down a floating single-point-mooring wind turbine having at least two energy conversion units, wherein each energy conversion unit has a rotor, having the following steps: shutting down one energy conversion unit according to shutdown parameters relating to the one energy conversion unit independently of the other energy conversion unit, detecting the shutdown of the one energy conversion unit, and shutting down the other energy conversion unit with shutdown parameters identical to the shutdown parameters of the one energy conversion unit. In particular, a case can occur in which a turbine controller initiates a shutdown procedure for the energy conversion unit assigned to the turbine controller, whereupon the turbine controller transmits the shutdown parameters to the master controller. In turn, the master controller instructs the other turbine controller to also shut down the second energy conversion unit with identical shutdown parameters, so that, taking into account the signal and calculation runtimes, an essentially simultaneous shutdown of both energy conversion units occurs.

In the following, the invention will be described in more detail with reference to an embodiment of a particularly preferred design, shown in the accompanying drawings. In the drawings:

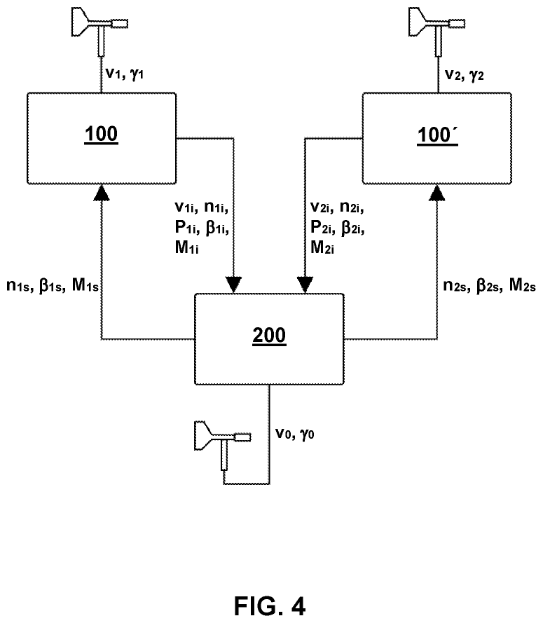

FIG. 4 shows a schematic view of a particularly preferably designed control system according to the invention, consisting of two turbine controllers and a master controller.

FIG. 4 shows a schematic view of a particularly preferably designed control system according to the invention for a single-point-mooring wind turbine with two wind energy conversion units each having a rotor, wherein the rotors are configured to rotate in opposite directions. The wind turbine has a turbine controller 100, 100′ associated with each energy conversion unit for independently regulating the particular energy conversion unit according to the operating parameters relating to the respective energy conversion unit. Also provided is a means for detecting a yaw angle relative to the average wind direction acting on the single-point-mooring wind turbine and a master controller 200 acting on the turbine controllers 100, 100′ for repositioning the single-point-mooring wind turbine when the single-point-mooring wind turbine is oriented at an angle relative to the average wind direction outside of a predetermined yaw angle range or when a yaw angle change occurring within a predetermined time is detected.

The average wind direction is determined by means of three wind measuring devices, wherein one wind measuring device is arranged on each energy conversion unit, and one wind measuring device is arranged in the region of the center of rotation of the wind turbine.

On the basis of the actual data supplied by the turbine controllers 100, 100′ of the rotational speed (n₁ᵢ, n₂ᵢ), the electrical power (P₁ᵢ, P₂ᵢ), the pitch angle (β₃ᵢ, β₂ᵢ), and torque (M₁ᵢ, M₂ᵢ) of the particular wind energy conversion unit as well as the wind speeds(v₀, v₁, v₂) and wind directions (γ₀, γ₁, γ₂) detected by wind measuring devices, the setpoint values for the rotational speed (n₁ₛ, n₂ₛ) and/or the pitch angle (β₁ₛ, β₂ₛ) and/or the torque (M₁ₛ, M₂ₛ) of the particular energy conversion unit 100, 100′ are determined by the master controller 200, and the master controller 200 implements them by transmitting them to the energy conversion unit 100, 100′.

1. A single-point-mooring wind turbine comprising:
at least two wind energy conversion units each having a rotor,
a turbine controller assigned to each energy conversion unit and designed to regulate the energy conversion unit in question independently of the other energy conversion unit in accordance with the operating parameters relating to the energy conversion unit in question; and
a master controller, which acts on the turbine controllers and is designed to specify operating parameters adapted to both energy conversion units.

2. The single-point-mooring wind turbine according to claim 1, wherein the energy conversion units are structurally identical with respect to the rotor diameter, the power, and/or the thrust characteristic.

3. The single-point-mooring wind turbine according to claim 1, further comprising at least one device for detecting a yaw angle that deviates from the average wind direction on the single-point-mooring wind turbine, wherein the master controller is configured to position the single-point-mooring wind turbine at a predetermined yaw angle relative to the average wind direction.

4. The single-point-mooring wind turbine according to claim 1, in that wherein the master controller is configured to position the single-point-mooring wind turbine within the predetermined yaw angle range when the single-point-mooring wind turbine is oriented at an angle relative to the average wind direction outside of the predetermined yaw angle range.

5. The single-point-mooring wind turbine according to claim 1, wherein when a yaw angle change occurring within a predetermined time is detected, the master controller is configured to effect a yaw angle change counteracting the amount of yaw angle change that has occurred.

6. The single-point-mooring wind turbine according to claim 1, wherein the rotors of the energy conversion units are configured to rotate in opposite directions.

7. A method for operating a floating single-point-mooring wind turbine having at least two energy conversion units in grid operation, wherein each energy conversion unit has a rotor, said method comprising
independently regulating the energy conversion units according to the operating parameters relating to the particular energy conversion unit within a predetermined yaw angle range that deviates from the average wind direction acting on the single-point-mooring wind turbine, and
regulating the other energy conversion unit that is matched to the operating parameters of the one energy conversion unit when
the single-point-mooring wind turbine is oriented at an angle to the average wind direction outside the predetermined yaw angle range to reposition the single-point-mooring wind turbine within the predetermined yaw angle range, or
when a yaw angle change occurring within a predetermined time is detected, to cause a yaw angle change counteracting the amount of yaw angle change that occurred.

8. The method according to claim 7, wherein the energy conversion units are regulated in a coordinated manner under the condition that the single-point-mooring wind turbine is oriented outside the predetermined yaw angle range for a predetermined time.

9. The method according to claim 7, wherein the predetermined yaw angle range is ±5° to ±10° from the average wind direction.

10. The method according to claim 7, wherein the single-point-mooring wind turbine is repositioned in particular by changing the torque of at least one of the energy conversion units, changing the pitch angle of at least one of the energy conversion units, and/or changing the rotor rotational speed of at least one of the energy conversion units.

11. The method according to claim 7, wherein the single-point-mooring wind turbine is repositioned by reducing the difference in rotor rotational speeds of the energy conversion units by means of a predetermined table reflecting the dependence of the yaw angle on the difference in rotor rotational speeds.

12. The method according to claim 7, further comprising shutting down the single-point-mooring wind turbine when a maximum yaw angle deviating from the average wind direction is exceeded.

13. A method for starting up a floating single-point-mooring wind turbine having at least two energy conversion units, wherein each energy conversion unit has a rotor, comprising:
operating one energy conversion unit at a constant rotational speed until the other energy conversion unit reaches a predetermined limit rotational speed, and
increasing the rotational speed of both energy conversion units after reaching the predetermined limit rotational speed until grid operation is achieved by coupling both energy conversion units to the grid.

14. A method for shutting down a floating single-point-mooring wind turbine having at least two energy conversion units, wherein each energy conversion unit has a rotor, comprising:
shutting down one energy conversion unit according to shutdown parameters relating to the one energy conversion unit independently of the other energy conversion unit,
detecting the shutdown of the one energy conversion unit, and
shutting down the other energy conversion unit with shutdown parameters identical to the shutdown parameters of the one energy conversion unit.
